(19) United States
(12) Patent Application Publication
(10) Pub. No.: US 2017/0084212 A1
(43) Pub. Date: Mar. 23, 2017

(54) INFORMATION DISPLAY DEVICE AND COMPUTER READABLE MEDIUM

(71) Applicant: CASIO COMPUTER CO., LTD., Tokyo (JP)

(72) Inventors: Kunihiro MATSUBARA, Tokyo (JP); Shingo OMATA, Tokyo (JP); Yuuichi SAGOU, Tokyo (JP)

(73) Assignee: CASIO COMPUTER CO., LTD., Tokyo (JP)

(21) Appl. No.: 15/267,529

(22) Filed: Sep. 16, 2016

(30) Foreign Application Priority Data
Sep. 18, 2015 (JP) 2015-185132

(51) Int. Cl. G09G 3/00; G06Q 30/06; G06F 3/14

(52) U.S. Cl. CPC G09G 3/002; G06F 3/14; G06Q 30/0641; G09G 2380/06

(57) ABSTRACT

An information display device includes a display and a processor. The display displays product information. The processor determines whether or not information relating to the product information is printable. The display displays a printability indication indicating that the information relating to the product information is printable in a case where the processor determines that the information relating to the product information is printable.

### CROSS REFERENCE TO RELATED APPLICATION

This application is based upon and claims the benefit of priority under 35 USC 119 of Japanese Patent Application No. 2015-185132 filed on Sep. 18, 2015, the entire disclosure of which, including the description, claims, drawings and abstract, is incorporated herein by reference in its entirety.

### BACKGROUND OF THE INVENTION

1. Field of the Invention

The present invention relates to an information display device and a computer readable medium.

2. Description of Related Art

Traditionally, there is known an equipment with image output device which projects contents on a screen which is formed in a shape conforming with the contour of a character in the contents or the like to leave strong impression on viewer (for example, see JP 2011-150221A).

In the equipment with image output device of JP 2001-150221A, in the case where a user selects a product which is described in the contents, merely a list of product information from which the user can make selection or the like is displayed. Thus, although the displayed product information includes information relating to the product information such as printable purchase tickets and coupons, the user cannot recognize such information.

### SUMMARY OF THE INVENTION

It is therefore, an object of the present invention to make it easy for a user to recognize whether the information relating to displayed product information can be printed.

In order to realize the above object, according to a first aspect of the present invention, there is provided an information display device, including:
a display which displays product information; and
a processor which determines whether information relating to the product information is printable,
wherein the display displays a printability indication indicating that the information relating to the product information is printable in a case where the processor determines that the information relating to the product information is printable.

According to the present invention, a user can easily recognize whether the information relating to displayed product information can be printed.

### BRIEF DESCRIPTION OF THE DRAWINGS

The above and other objects, advantages and features of the present invention will become more fully understood from the detailed description given herein below and the appended drawings which are given by way of illustration only, and thus are not intended as a definition of the limits of the present invention, and wherein:

FIG. 1 is a block diagram showing a functional configuration of a digital signage device according to an embodiment;

FIG. 2 is a schematic view of a display screen shown in FIG. 1;

FIG. 3 shows an example of data storage in a product management information storage;

FIG. 4 is a flowchart showing a display control process which is executed by a processor shown in FIG. 1;

FIG. 5 shows an example of a menu window; and

FIG. 6 shows an example of a details window.

### DESCRIPTION OF THE PREFERRED EMBODIMENTS

Hereinafter, a preferred embodiment of the present invention will be described with reference to the drawings. In the following embodiment, an example where the digital signage device 1 is applied as the information display device of the present invention will be described. However, the present invention is not limited to the examples shown in the drawings.

### Configuration of Digital Signage Device 1

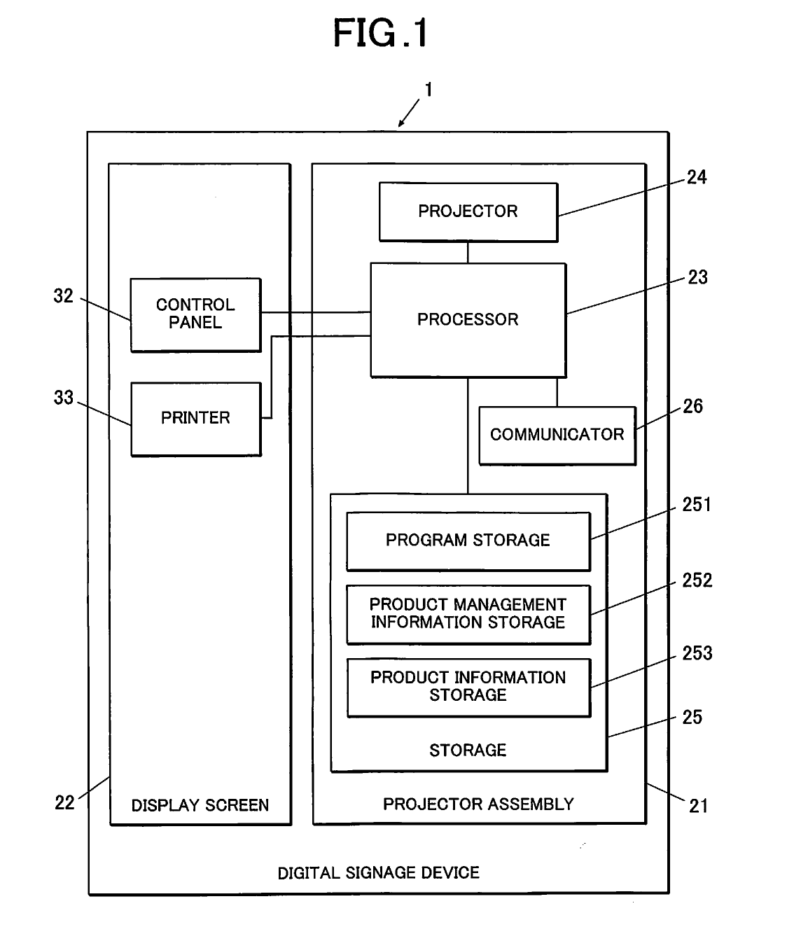

FIG. 1 is a block diagram showing the main controlling configuration of the digital signage device 1 according to the embodiment. For example, the digital signage device 1 is set in a store or the like and is an device which outputs information relating to a product in a selected language for customers such as visitors from overseas who is not used to communication in Japanese.

As shown in FIG. 1, the digital signage device 1 includes a projector assembly 21 which projects video light and a display screen 22 which receives the video light which is emitted from the projector assembly 21 on the back surface thereof and projects the image light on the front surface thereof.

First, the projector assembly 21 will be described. The projector assembly 21 includes a processor 23, a projector 24, a storage 25 and a communicator 26. As shown in FIG. 1, the projector 24, the storage 25 and the communicator 26 are connected to the processor 23.

The processor 23 includes a CPU (Central Processing Unit) which executes various types of programs stored in the storage 25 to perform predetermined arithmetic and control individual components and a memory which is used as the working area when executing a program (both not shown).

The projector 24 is a projection device which converts image data for displaying an image which is output from the processor 23 into video light and emits the video light to the display screen 22. As for the projector 24, a DLP (Digital Light Processing) (registered trademark) projector which utilizes DMDs (digital micro-mirror devices) may be used, the DMDs being display elements which form light figures with reflection light obtained by rapidly turning the inclined angles of micro-mirrors (in the case of XGA, 1024 pixels in the lateral direction and 768 pixels in the vertical direction) on and off, where the micro-mirrors are arranged in an array, for example.

The projector 24 forms the display with the image display 27.

The storage 25 is configured of a HDD (Hard Disk Drive), a non-volatile semiconductor memory or the like. As shown in FIG. 1, the storage 25 includes a program storage 251, a product management information storage 252, a product information storage 253 and the like.

In the program storage 251, a system program and various types of processing programs which are executed by the processor 23, data required to execute the programs and the like are stored.

As shown in FIG. 3, in the product management information storage 252, information indicating whether a product is a duty-free product, whether a product is a by-register product, and whether a product is an attendance-required product is stored in association with product identification information (product ID). By-register products are the products which are placed near the register and is sold by a staff taking an order from a customer at the register. Attendance-required products are products which need to be attended and handled by a staff when the product is to be sold.

In the product information storage 253, information relating to a product (product information (product name), detailed information on the product (for example, price, and content, whether allergen material is used, etc. in case of food), product image, etc.) is stored in various languages in association with the product identification information (product ID).

The communicator 26 is configured of a modem, a router, a network card or the like, and carries out communication with external devices.

Next, the display screen 22 will be described.

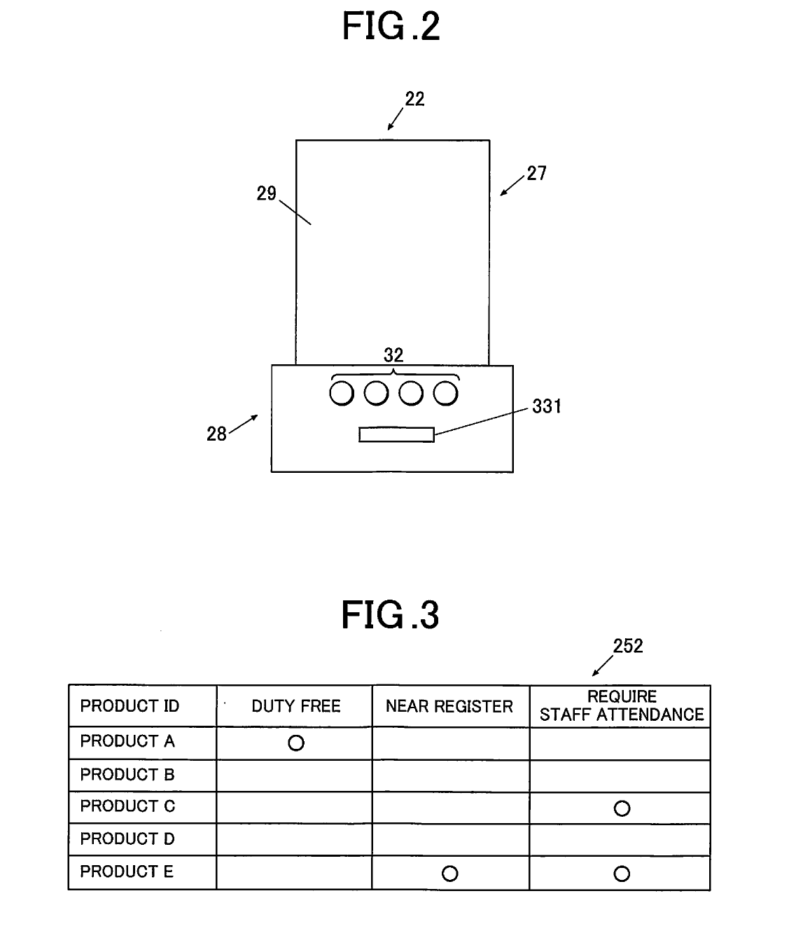

FIG. 2 is the front view showing the schematic view of the display screen 22. As shown in FIG. 2, the display screen 22 includes an image display 27 and a base 28 which supports the image display 27.

The image display 27 is a screen in which a film screen for rear projection formed by film shaped Fresnel lenses being layered is applied on the surface of a light transmitting board 29, for example, an acrylic board, which is disposed so as to be approximately perpendicular to the emitting direction of video light.

The base 28 includes a control panel 32 and a printer 33.

The control panel 32 includes operation buttons, and outputs a pressed signal of an operation button to the processor 23. For example, the control panel 32 functions as a selector.

The printer 33 prints a purchase card of a product on a sheet in accordance with an instruction from the processor 23 and outputs the printed purchase card from the outlet 331.

The control panel 32 and the printer 33 are connected to the processor 23 as shown in FIG. 1.

### Operation of Digital Signage Device 1

Next, operation of the digital signage device 1 will be described.

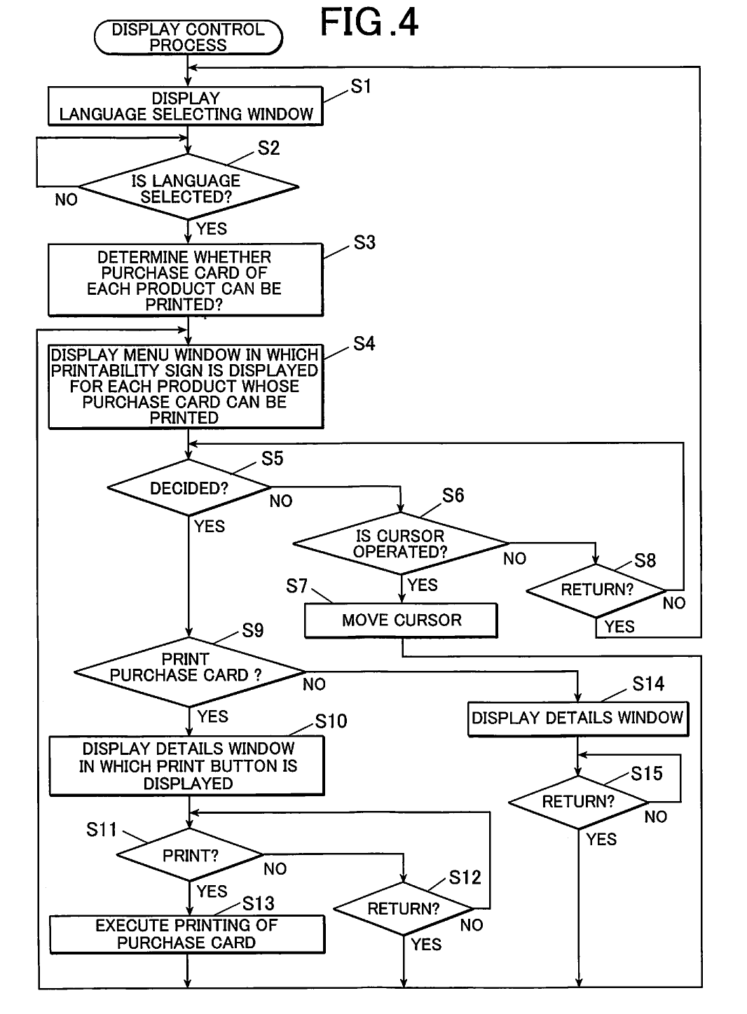

FIG. 4 shows a flowchart of the display control process which is executed in the digital signage device 1. The display control process is executed by the processor 23 cooperating with a program stored in the program storage 251.

First, the processor 23 makes the projector 24 display a language selection window in the image display 27 (step S1).

Although it is not shown in the drawings, the language selection window is a window in which a list of languages (the languages in which production information is stored in the product information storage 253) in which product information can be displayed in the digital signage device 1 is displayed and at the same time, cursor buttons and an ok button which are associated with individual operation buttons in the control panel 32 are displayed. A user can select the language in which information is to be displayed in the digital signage device 1 by pressing the operation buttons associated with the cursor buttons in the language selection window to move the cursor to the desired language and pressing the operation button associated with the ok button.

After the language is selected by the operation performed on the control panel 32 (step S2; YES), the processor 23 determines whether each product whose product information is displayed in the menu window 271 is the product whose purchase card can be printed (step S3).

In step S3, the processor 23 refers to the product management information storage 252 to determine whether each product whose product information is to be displayed in the menu window 271 is at least one of duty-free product, by-register product and attendance-required product. If the processor 23 determines that the product is at least one of duty-free product, by-register product and attendance-required product, the processor 23 decides that this is a product whose purchase card can be printed.

Next, the processor 23 makes the menu window 271 in the selected language be displayed in the image display 27, the printability signs 2711 being displayed in association with the product information of the products whose purchase cards can be printed (step S4).

In step S4, the processor 23 refers to the product information storage 253 to read out the product information (product name) of each product in the selected language, generates image data of the menu window 271 in which the printability signs 2711 indicating that the purchase cards can be printed being displayed in association with the product information of the products whose purchase cards can be printed, and makes the projector 24 display the image based on the image data in the image display 27.

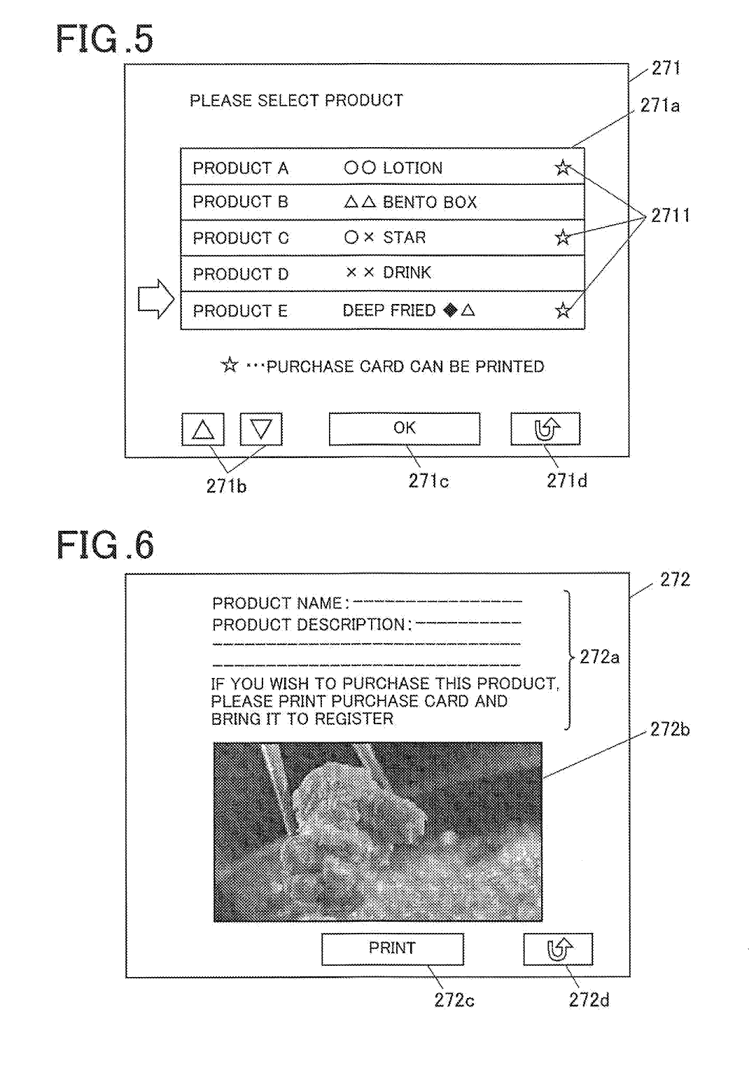

FIG. 5 shows an example of the menu window 271. As shown in FIG. 5, the list of product information 271a, the cursor buttons 271b for moving the cursor for selecting a product, the ok button 271c and the return button 271d are displayed in the menu window 271. Although the menu window 271 is displayed in Japanese in FIG. 5, in the actual cases, the menu window 271 is displayed in the selected language. A user can select a product by pressing the operation buttons in the control panel 32 corresponding to the cursor buttons 271b to move the cursor to the product information of the desired product and by pressing the operation button corresponding to the ok button 271c. In the list of product information 271a, the printability sign 2711 is displayed in association with each product whose purchase card can be printed, the printability sign 2711 being printability indication indicating that the purchase card can be printed.

The purchase card is a piece of paper. One can purchase a product by showing the purchase card to a staff at the register. For example, on a purchase card, the product name is printed in Japanese and in the selected language and the barcode of the product is also printed. In the embodiment, purchase cards can be printed with respect to the products each of which is at least one of duty-free product, by-register product and attendance-required product, for example.

Here, the duty-free product, by-register product and attendance-required product are the products which requires to have a conversation with a staff in order to purchase such products. However, since visitors from overseas or the like have difficulty communicating with staffs and there are cases where it is difficult for visitors to purchase such products. In view of the above, in the embodiment, purchase cards on which product information and the like is printed in Japanese and in the selected language can be printed with respect to the duty-free products, by-register products or attendance-required products so that visitor from overseas can purchase such products just by handing the purchase cards to staffs. In the menu window 271, printability signs 2711 are displayed in association to product information of the products whose purchase cards can be printed among the product information displayed in the list of product information 271a. Thus, a user can easily recognize whether each product displayed in the menu window 271 is the product whose purchase card can be printed.

Next, the processor 23 determines whether the operation button corresponding to the ok button 271c in the menu window 271 is pressed (step S5).

If the processor 23 determines that the operation button corresponding to the ok button 271c is not pressed (step S5; NO), the processor 23 determines whether one of the operation buttons corresponding to the cursor buttons 271b is pressed (step S6). If the processor 23 determines that one of the operation buttons corresponding to the cursor buttons 271b is pressed (step S6; YES), the processor 23 moves the cursor in the menu window 271 (step S7) and returns to step S4.

If the processor 23 determines that one of the operation buttons corresponding to the cursor buttons 271b is not pressed (step S6; NO), the processor 23 determines whether the operation button corresponding to the return button 271d is pressed (step S8). If the processor 23 determines that the operation button corresponding to the return button 271d is not pressed (step S8; NO), the processor 23 returns to step S5. If the processor 23 determines that the operation button corresponding to the return button 271d is pressed (step S8; YES), the processor 23 returns to step S1. That is, the language selection window is displayed again.

If the processor 23 determines that the ok button 271c is pressed (step S5; YES), the processor 23 determines whether the product information selected in the menu window 271 is the product information of the product whose purchase card can be printed (step S9).

If the processor 23 determines that the product information selected in the menu window 271 is the product information of the product whose purchase card can be printed (step S9; YES), the processor 23 makes the details window 272 in which the print button 272c is displayed be displayed in the image display 27 (step S10).

In step S10, the processor 23 refers to the product information storage 253 to read out the information relating to the product of the selected product information in the selected language, generates image data of the details window 272, and makes the projector 24 display the image corresponding to the generated image data in the image display 27.

FIG. 6 shows an example of the details window 272. As shown in FIG. 6, product name and detailed description of product 272a, a product image 272b, the print button 272c and the return button 272d are displayed in the details window 272. Although the details window 272 is displayed in Japanese in FIG. 6, in the actual cases, the details window 272 is displayed in the selected language. A user can print out the purchase card of the product which is being displayed in the screen by pressing the operation button corresponding to the print button 272c.

Next, the processor 23 determines whether the operation button corresponding to the print button 272c is pressed (step S11).

If the processor 23 determines that the operation button corresponding to the print button 272c is not pressed (step S11; NO), the processor 23 determines whether the operation button corresponding to the return button 272d is pressed (step S12). If the processor 23 determines that the operation button corresponding to the return button 272d is not pressed (step S12; NO), the processor 23 returns to step S11. If the processor 23 determines that the operation button corresponding to the return button 272d is pressed (step S12; YES), the processor 23 returns to step S4.

In step S11, if the processor 23 determines that the operation button corresponding to the print button 272c is pressed (step S11; YES), the processor 23 makes the printer 33 print the purchase card of the product whose detail is being displayed presently and output the purchase card from the outlet 331 (step S13), and returns to S4.

The purchase card which is printed in step S13 has at least the product name printed in Japanese and in the selected language, and the barcode for identifying the product. Also, the price of the product may be printed. In such way, just by a customer checking the product name on the purchase card and handing the purchase card to a staff, the staff can understand which product the customer wishes to purchase and can sell the product to the client. Further, by reading the barcode on the purchase card, the process to be carried out at the register such as product registration and the like can be omitted and simplified.

Here, purchase cards of duty-free products may have what the customers need to carry out in duty-free procedure and the flow of duty-free procedure such as “If you wish to process duty-free procedure, please show your passport with the purchase card” printed in the selected language. In such way, the duty-free procedure can be carried out smoothly.

In step S9, if the processor 23 determines that the product selected in the menu window 271 is not the product whose purchase card can be printed (step S9; NO), the processor 23 makes the details window 273 without the print button be displayed in the image display 27 (step S14). Other than the print button 272c not being displayed, the details window 273 here is the same as that of the details window 272 shown in FIG. 6.

If the return button in the control panel 32 is pressed in the details window 273 (step S15; YES), the processor 23 returns to step S4.

The processor 23 repeats the process of step S4 through step S15 until the power of the digital signage device 1 is turned off.

As described above, on each of the purchase cards of the products which are printed if the operation button corresponding to the print button 272c of the details window 272 is pressed, the product name is printed in Japanese and in the selected language. Further, the barcode for identifying the product is printed. Thus, just by printing the purchase card, confirming the product name and showing the card to a staff, the user can let the staff know which product the user wishes to purchase. The staff can understand which product the user wishes to purchase just by looking at the purchase card. Furthermore, product registration can be done just by reading the barcode printed on the purchase card at the register. If the product is a duty-free product, duty-free procedure can be carried out based on the read barcode and the task to be carried out at the register can be simplified.

As described above, according to the digital signage device 1, the processor 23 determines whether individual products are the products whose purchase cards can be printed and displays the menu window 271 in which the printability signs 2711 are made to be associated with the product information of the products whose purchase cards can be printed in the image display 27.

Thus, a user can easily recognize whether the purchase cards of the products whose product information is being displayed can be printed.

For example, in the case where a product is at least one of duty-free product, by-register product and attendance-required product, the processor 23 determines whether the purchase card of the product can be printed.

Thus, for example, in the case where a customer who is a visitor from oversea having difficulty communicating with a staff in Japanese wishes to purchase a product which requires to communicate with a staff in order to make the purchase, such as duty-free product, by-register product or attendance-required product, the customer can purchase such product just by printing the purchase card of such product and handing the card to the staff.

Further, in the case where product information which is associated with a printability sign 2711 is selected in the menu window 271, the processor 23 makes the details window 272 in which the detailed information of the selected product and the print button 272c for printing the purchase card of the product are shown be displayed in the image display 27. Thus, a user can understand the detail of the product before printing the purchase card of the product.

The above description of the embodiment is merely a preferred example of the digital signage device according to the present invention and is not limitative in any way.

For example, in the above embodiment, an example of the case where the purchase card of a product relating to product information is printed as the information relating to the product information is described. However, the discount coupon or the like of a product relating to product information may be printed.

Further, in the above embodiment, the present invention is described by taking the case where the digital signage device 1 is set in a store in Japan and provides description of products to visitors from overseas as an example. However, this situation is not limitative in any way. The digital signage device which provides product description to visitors can also be used in other countries. In such cases, on the purchase cards, product names and the like are printed in the language of the country in which the digital signage device 1 is being used instead of in Japanese.

Moreover, in the above embodiment, the case where the present invention is applied to a digital signage device which displays images by a projector projecting images on a screen is described as an example. However, this configuration is not limitative in any way. For example, the present invention can be applied to content replay devices including other display devices such as a liquid crystal display, a plasma display, etc. and the same advantages can still be obtained.

In addition, detailed configuration and detailed operation of individual components of the digital signage device can be arbitrarily modified within the scope of the invention.

Although various exemplary embodiments have been shown and described, the invention is not limited to the embodiments shown. Therefore, the scope of the invention is intended to be limited solely by the scope of the claims that follow.

What is claimed is:

1. An information display device, comprising:
a display which displays product information; and
a processor which determines whether or not information relating to the product information is printable,
wherein the display displays a printability indication indicating that the information relating to the product information is printable in a case where the processor determines that the information relating to the product information is printable.

2. The information display device of claim 1, wherein the information relating to the product information is a purchase card of a product corresponding to the product information.

3. The information display device of claim 2, wherein when the product corresponding to the product information is at least one of a duty-free product, a product which a staff takes an order to sell the product and a product which requires staff's attendance, the processor determines that the information relating to the product information is printable.

4. The information display device of claim 1, wherein
the display displays a list of a plurality of product information,
the display includes a selector for selecting product information among the list of product information, and
when product information with which the printability indication is displayed is selected, the display displays detailed information of the selected product and a print button for printing the information relating to the product information.

5. The information display device of claim 2, wherein
the display displays a list of a plurality of product information,
the display includes a selector for selecting product information among the list of product information, and
when product information with which the printability indication is displayed is selected, the display displays detailed information of the selected product and a print button for printing the information relating to the product information.

6. The information display device of claim 3, wherein
the display displays a list of a plurality of product information,
the display includes a selector for selecting product information among the list of product information, and
when product information with which the printability indication is displayed is selected, the display displays detailed information of the selected product and a print button for printing the information relating to the product information.

7. A non-transitory computer readable medium which stores a program which makes a computer included in an information display device execute:
a display process of displaying product information;
a determining process of determining whether or not information relating to the product information is printable; and
a display control process of displaying a printability indication indicating that the information relating to the product information is printable in a case where the information relating to the product information is determined to be printable.
